(19) United States
(12) Patent Application Publication
(10) Pub. No.: US 2009/0132659 A1
(43) Pub. Date: May 21, 2009

(54) Enhancing Collaboration Opportunities for a Reply to an Electronic Message

(75) Inventors: Michael Dennis Facemire, Pittsboro, NC (US); Michael C. Wanderski, Durham, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/940,500

(22) Filed: Nov. 15, 2007

(51) Int. Cl. G06F 15/16

(52) U.S. Cl. 709/206

(57) ABSTRACT

It is not unusual for an e-mail message to request replies from multiple addressees. To enhance the opportunities for collaborations on a reply to the e-mail message, each of the messaging servers supporting the addressees maintains a message record identifying each addressee that signals he has begun working on a reply. When the message record indicate that at least two addressees are working on a reply, a notice that multiple addressees are concurrently working on a reply is immediately sent to each of the addressees, creating a collaboration opportunities for the addressees. The notice may take the form of a system-generated instant message.

### BACKGROUND OF THE INVENTION

Electronic messaging systems, particularly e-mail systems, have largely supplanted postal mail for business communications both among people working for the same organization and among people working for different organizations.

E-mail systems enable any user to provide information to and seek information from a large number of message recipients almost instantaneously with a single, outgoing e-mail message having a long addressee list. The practice of broadcasting requests for information is understandably popular with senders, who perceive it as an efficient way for them to conduct their own business.

Unfortunately, the fact that broadcasting requests for information to many recipients may be efficient for the sender does not necessarily mean it is efficient for recipients. It is not uncommon for a recipient of a broadcast e-mail to spend a significant amount of time and effort drafting a reply, to hit the “send” button on the workstation keyboard and to return to the e-mail system inbox only then to learn that another recipient has already sent a reply that obsoletes all of the first recipient's efforts. This can easily happen to more than one recipient of a broadcast e-mail, which multiplies the loss of recipient productivity.

In fact, the loss of productivity can extend beyond the time required to generate an initial replies to a broadcast e-mail. If a first recipient of a broadcast e-mail believes a reply already provided by another recipient is incomplete or misleading, the first recipient may feel compelled to clarify or correct the other recipients reply by sending a supplemental reply to the original sender and one or more recipients of the original broadcast E-mail. Clearly, if the efforts expended by multiple recipients for broadcast e-mail are duplicative or must be extended to deal with perceived errors and omissions in a reply prepared by only one of the recipients, there is room for improvement.

### BRIEF SUMMARY OF THE INVENTION

The present invention may be implemented as a method for enhancing collaboration opportunities for a reply to an electronic message previously sent to two or more messaging clients. When the first user initiates preparation of a reply to the message, a notice is received. Similarly, a notice is received when a second user initiates preparation of a reply to the same message. A notice is immediately sent to at least one of the users that another user has begun work on a reply to the same message.

The present invention may also be implemented as a computer program product for enhancing collaboration opportunities for our reply to an electronic message previously sent to two or more messaging clients. The computer program product includes a computer usable medium embodying computer usable program code. The embodied program code includes code configured to receive a notice from the first messaging client to which the message was previously sent that the first user has initiated preparation of a reply. The embodied program code also includes code configured to receive a notice from a second messaging client to which the message was previously sent by the second user has also initiated preparation of a reply. Other embodied program code is configured to send an immediate notice to at least one of the first and second users that another user has begun work on a reply to the same message.

Finally, the present invention may be implemented as a messaging server for enhancing collaboration opportunities for a reply to an electronic message previously set to two or more messaging clients. The server includes a receiver component for receiving notices from two or more messaging clients that users of the clients have initiated preparation of replies to the previously sent message. The server also includes a notification component for sending an immediate notice to at least one of the users that another user has begun work on a reply to the same message.

### BRIEF DESCRIPTION OF THE SEVERAL VIEWS OF THE DRAWINGS

FIG. 1 is a schematic illustration of messaging components in the network in which the present invention may be implemented.

FIG. 2 is a block diagram of essential components of a messaging server implementing the present invention.

FIG. 3 is a data structure for a message record employed in an implementation of the present invention.

FIG. 4 is a data structure for addressee data fields in the message record illustrated in FIG. 3.

FIG. 5 is a flow chart of essential operations performed in implementing the present invention.

FIG. 6 is a schematic representation of the basic hardware infrastructure of a general purpose programmable computer system that could be used for a messaging server implementing the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

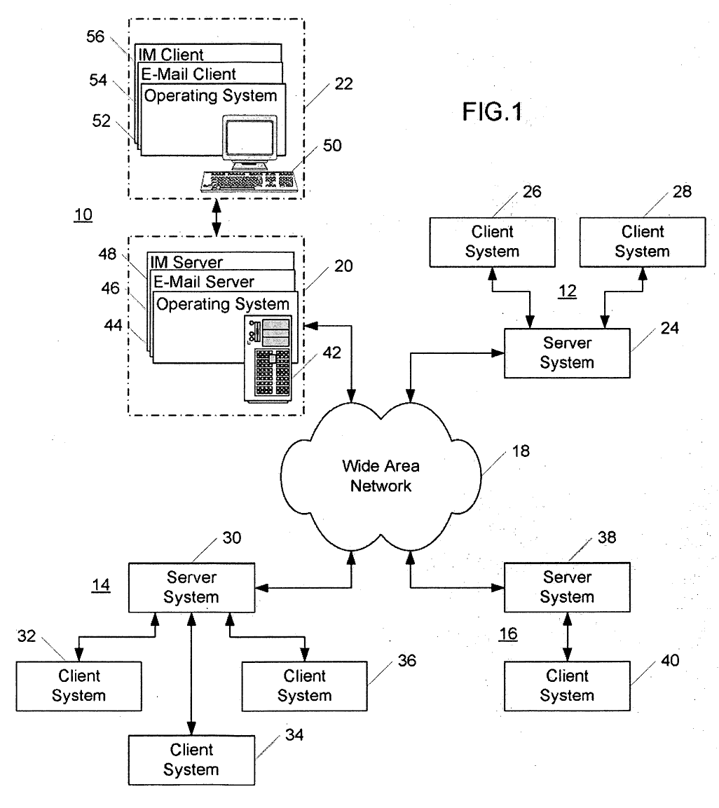

FIG. 1 is an overview of essential elements of an electronic messaging network. Several electronic messaging systems 10, 12, 14, 16 are shown interconnected through a wide area network 18. The representation of wide area network 18 is highly simplified and omits the numerous networking hardware devices (such as routers, switches, backbone servers, etc.) and data transmitters/receivers/media that are actually involved in moving data originating in one of the electronic messaging systems to other of the electronic messaging systems.

Electronic messaging systems typically implement a client/server architecture with a single messaging server supporting many messaging clients. To simplify the network illustration, messaging servers are illustrated supporting unrealistically low numbers of messaging clients. Specifically, messaging server 20 in system 10 is shown supporting a single messaging client 22. Similarly, messaging server 24 in system 12 is shown supporting two clients 26 and 28, messaging server 30 in system 14 is shown supporting three messaging clients 32, 34, 36 and messaging server 38 in system 16 is shown supporting a single client 40. In practice, each messaging server would be expected to support hundreds or even thousands of messaging clients.

As shown for system 10, a messaging server includes a server hardware unit 42 that executes operating systems software 44 and at least e-mail server software 26. At a basic level, the e-mail server software stores e-mail messages generated by local clients or received from other messaging systems through the wide area network 18 and handles the distribution of messages addressed to both local clients and to clients in remote messaging systems.

As also shown for system 10, each e-mail client includes a client hardware unit 50 (often a personal computer or other workstation) controlled by operating system software 52. The client system 22 includes e-mail client software 54 that allows a user of the client system to receive, review and reply to e-mail messages provided through server 20.

A conventional e-mail system is a store-and-forward system that receives and stores each e-mail message at a local server until a user of the client system instructs the server to open the stored e-mail message, usually by invoking an “open e-mail” function in an e-mail system graphical user interface. E-mail systems are often supplemented by Instant Messaging (IM) systems, another type of electronic messaging system that can be used to deliver a (usually) brief message generated by one user directly to the video monitor of another user in the form of a popup “chat” window that is difficult for the monitor user to ignore. The primary advantage of an instant message relative to an e-mail message is that the message content is virtually immediately available to the recipient without requiring that the recipient enter a command to retrieve the message.

Instant messaging systems are also client/server systems in which a server system, such as server 20, executes instant messaging server software 48 while each client system, such as client 22, executes counterpart instant messaging client software 56. While the drawing shows the same server hardware unit 42 executing both e-mail and instant messaging server applications, separate servers may be used to support the two different types of messaging applications. Conversely, e-mail functions and instant messaging functions may be so tightly integrated that the same server software product will support both types of functions in a single server system and that the same client software product will support both types of functions in a single client system.

The present invention takes advantage of the different message delivery properties of e-mail systems and instant messaging systems to enhance opportunities for collaboration among users who intend to reply to a single e-mail message addressed to multiple users. The present invention is implemented in a messaging server that stores a message record for any e-mail message originating at a local client or received from a remote mail server because it is addressed to one or more local clients. The message record uniquely identifies an e-mail message and all pending replies to the message.

The mail server is notified whenever preparation of a reply to the e-mail is initiated at a client, either local or remote. When the first notice is received for a particular message, the message record is modified to indicate a first user is working on a reply to the message. No other action is taken. When a second notice is received, indicating that another user has also begun working on a reply to the message, at least one of the two users is immediately notified, preferably through the use of a system-generated instant message, to give the notified user(s) an opportunity to collaborate on a reply will it is still in preparation.

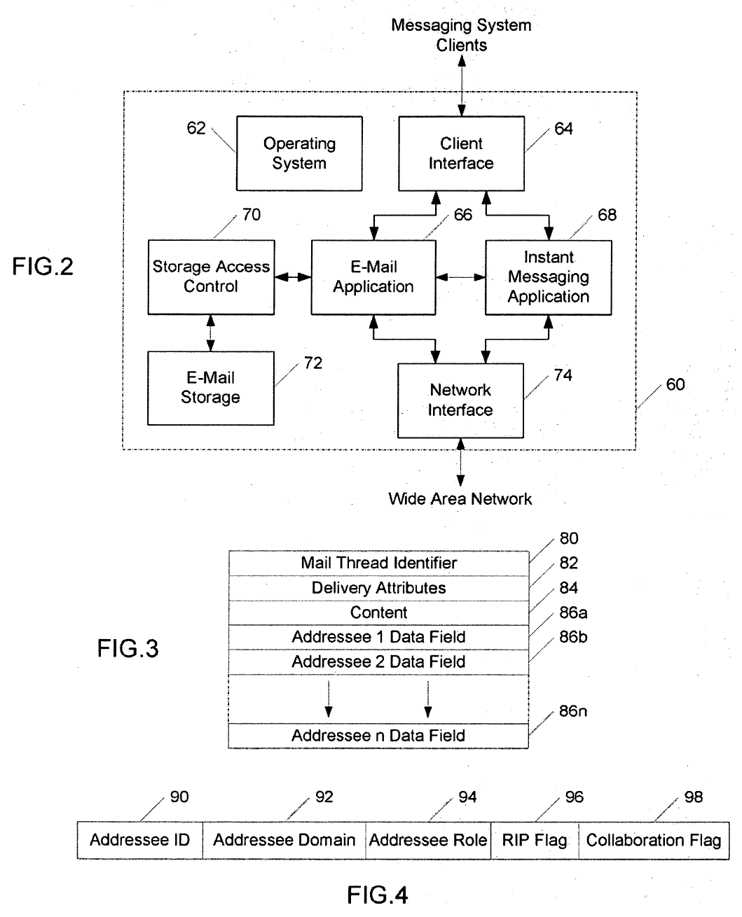

FIG. 2 is a block diagram of essential components of a messaging server 60 implementing the invention. The messaging server 60 includes, of course, operating systems software 62 and an e-mail application program 66 that interfaces with local clients through a client interface 64 and with remote messaging servers through a network interface 74 to a wide area network. The e-mail application program 66 includes a storage access control subsystems 70 for controlling the storage and retrieval of e-mail messages from an e-mail storage unit 72. The e-mail storage unit 72 also stores message records that include essential information about stored e-mail documents.

In one embodiment of the invention, the messaging server 16 also includes an instant messaging application program 68 used to control the flow of instant messages between local clients and clients at remote messaging systems. As will be explained in more detail later, there is a logical link between the e-mail application program 66 and the instant messaging application program 68 that enables the e-mail application program 66 to initiate an operation by the instant messaging application program under specific conditions.

FIG. 3 illustrates a data structure of the message record for an e-mail message stored in the e-mail storage unit 72. The data structure includes a thread identifier field 80 for storing a value that uniquely identifies the stored e-mail message, a delivery attributes field 82 which typically includes multiple fields with values indicating whether the data should be encrypted, whether received of the message should be acknowledged by an electronic “return receipt”, whether the message should be classified as confidential, etc., and a content field 84 for storing the actual message content. In accordance with the present invention, the thread record was also include one or more addressee data fields 86a, 86b, . . . 86n for both the originator of the message and any recipients associated with either local or remote clients.

FIG. 4 illustrates a preferred data structure for an addressee data field in a message record. The addressee data field includes an addressee ID subfield 90, which may consist of a user ID, and addressee domain subfield 92 that identifies the domain in which the user (or more specifically, the client system associated with the user) is located, and an addressee type subfield 94 that specifies the user's role relative to the specific message. Different e-mail systems may define user roles slightly differently. Typically, a user may be categorized as a sender, a recipient for whom the message was directly intended (sometimes referred to as a To: list member), or a recipient to whom the message was sent for information (sometimes referred to as a CC: list or a BlindCC: list).

In accordance with the present invention, the addressee data field includes at least two additional subfields, a RIP (reply in preparation) subfield 96 and a collaboration subfield 98. The RIP subfield 96 may be a single bit field that is set to “1” when the addressee begins working on a reply to a message and remains at “1” until the addressee stops working on the replying. The signal that an addressee has begun working on a reply may be triggered by the addressee's selection of a function button such as “Reply” or “Reply to All” on the addressee's graphical user interface to the e-mail application program. The signal that an addressee has stopped working on a reply can be generated either when the addressee closes the reply screen in the e-mail client and graphical user interface without actually sending anything to another party or when the addressee completes and sends a reply to one or more other parties.

The collaboration subfield 98 can also be a single bit field that is set to “1” only for an addressee that displays an interest in collaborating with others on a reply to the message. The default value for the collaboration subfield is a “0”, indicating an addressee who has yet to show any interest in collaborating with others.

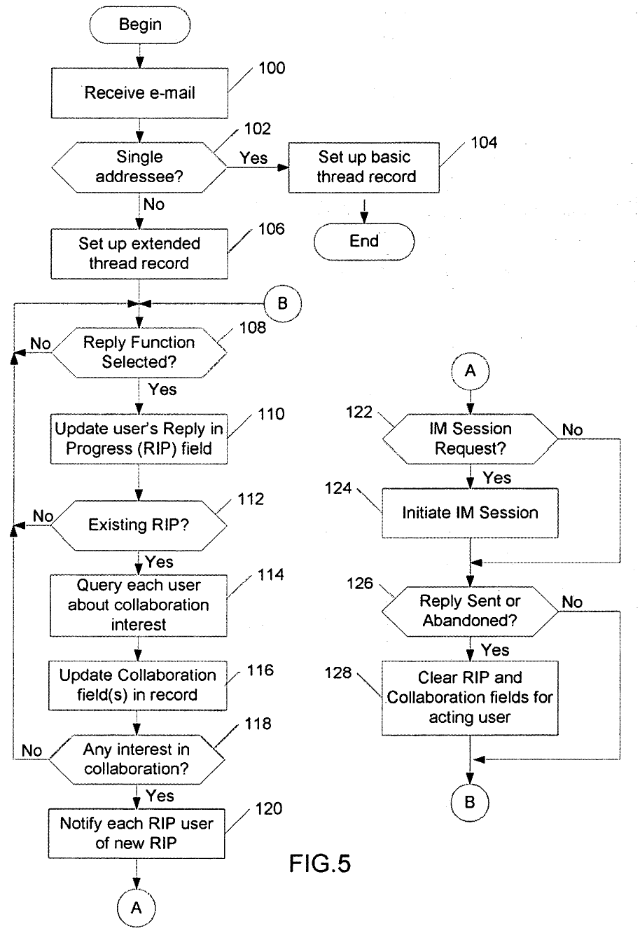

FIG. 5 is a flow chart of essential operations occurring in a messaging server implementing the present invention. The collaboration-enhancing process begins when an e-mail message is received at the messaging server in an operation 100. The message is checked in an operation 102 to determine whether it is being sent to a single addressee. If a message is sent to a single addressee, by definition there can be no opportunities for collaboration among multiple recipients of the message. A basic thread record is set up by the messaging server in operation 104 and the collaboration-enhancing process is terminated. If, however, operation 102 shows that the message is addressed to multiple recipients, an extended thread record as set up in an operation 106. The extended thread record includes the addressee data fields discussed earlier with each addressee data field including a RIP (Reply in Preparation) subfield and a Collaboration subfield. As noted earlier, a “1” in the RIP field indicates that the addressee is begun working on a reply to the identified message while a “1” in the Collaboration field indicates that the addressee as indicated an interest in collaborating with others on preparation of a reply. Initially, both subfields contain “0” values since the addressee won't even have seen the message (unless he is the sender), let alone know whether he wants to initiate preparation of a reply or collaborate with others on a reply.

The collaboration-enhancing process then enters a wait loop in which the system waits for an indication (operation 108) that user of a client system has initiated preparation of a reply to the message, perhaps by selecting a Reply button in the e-mail system graphical user interface. The client system may either be a local client that communicates directly with the messaging server or a remote client that communicates through its own messaging server and the wide area network.

When a messaging server receives a “reply function selected” signal, the addressee data field in the thread record is updated by writing a “1” into the RIP subfield in an operation 110. A check 112 is then made as to whether any of the other addressee data fields in the message record already includes a “1” value in its RIP subfield. If no other “1” values are found, indicating that a single addressee has begun working on a reply, program control loops back to the wait loop including operation 108 and remains in that wait loop until a message is received indicating that another addressee have also begun working on a reply to the same message.

When the check 112 shows that at least two addressees have concurrently begun working on replies to the message, the messaging server queries (operation 114) both of the identified users to determine whether either is interested in collaborating with other users If an user indicates an interest in collaboration, the collaboration subfield in the user record in an operation 116 is updated to indicate the user's interest. If it is determined (operation 118) that none of the users is interested in collaborating, program control returns to the wait loop that includes operation 108 to await indications that still other addressees have begun preparation of replies to the message. However, until at least one of the users shows some interest in collaboration, no steps are taken to notify any user that someone else is concurrently working on a reply to the message.

Once query 118 indicates that at least one user is interested in collaboration, a notice is sent (operation 122) to one or more of the users previously identified as working on a reply. The notice may be sent as a system-generated instant message or by another appropriate messaging technology such as JMS (Java Messaging Service). Whether the notice is sent to some or all of the users previously identified as working on replies to the message is a matter of choice. In a preferred embodiment, the notice is sent to all of the users on the premise that even those users who previously expressed no interest in collaboration may change their minds.

Preferably, each notice that is sent to other users includes a timestamp indicating when other users began working on replies to the message. This information gives a user a sense of how quickly the user must act to let others know he is interested in collaborating on a reply. If another user has been working on a reply for a while, the user receiving the notice will probably conclude that he must act quickly if he wishes to influence the other user's reply.

At this point in the collaboration-enhancing process, every user who has initiated preparation of a reply to an e-mail message will be aware of every other user who has also initiated preparation of a reply to the same message. It would be possible to automatically set up a dialogue among the users, perhaps by automatic initiation of an instant messaging chat session. In a preferred embodiment, however, no particular mode of collaboration is imposed upon the users on the premise that users will tend to select a mode of collaboration that is most effective for them under the circumstances. For particular users, the most effective collaboration may be for one user to pick up a telephone and call another user. For other particular users, the most effective collaboration may occur when one user stands up, walks to a nearby office and sits down with another user to discuss the pending reply face-to-face.

In a significant number of instances, however, users will make use of an integrated or standalone instant messaging system to achieve the desired collaboration. To this end, a graphical user interface may be employed in each messaging client that makes it easy for any of the users to request an IM session with one or more of the other users. If an operation 122 indicates an IM session is requested, the IM session is initiated in an operation 124. Control of the session, however, occurs outside the scope of the collaboration-enhancing process being described. If operation 122 does not indicate that any of the users have requested an IM session, the system begins to monitor each of the users previously identified as having initiated preparation of a reply to determine (in an operation 126) whether the user is apparently still working on a reply or has terminated the effort either by completing and sending a reply or by closing the reply screen in the client system graphical user interface. If a user terminates preparation of a reply, it is assumed that user no longer has an interest in collaborating with others who then began working on replies. The user's data record is updated by clearing the RIP and Collaboration fields in an operation 128. Preferably, the clearing of one user's data record has no effect on the data records for other users.

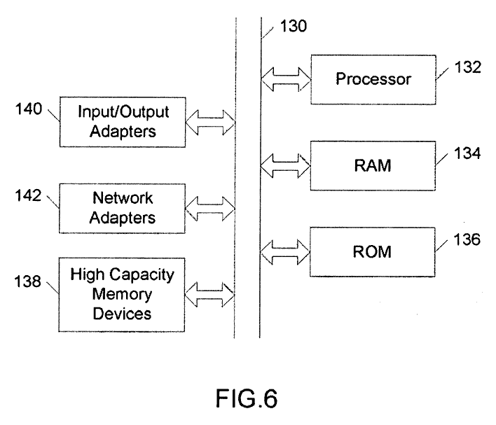

FIG. 6 is a block diagram of a hardware infrastructure for a general-purpose computer device that could, when programmed properly, be used for a messaging server implementing the present invention. The infrastructure includes a system bus 130 that carries information and data among a plurality of hardware subsystems including a processor 132 used to execute program instructions received from computer applications running on the hardware. The infrastructure also includes random access memory (RAM) 134 that provides temporary storage for program instructions and data during execution of computer applications and are read only memory (ROM) 136 often used to store program instructions required for proper operation of the device itself, as opposed to execution of computer applications. Long-term storage of programs and data is provided by high-capacity memory devices 138, such as magnetic hard drives or optical CD or DVD drives.

In a typical computer system, a considerable number of input/output devices are connected to the system bus 130 through input/output adapters 140. Commonly used input/output devices include monitors, keyboards, pointing devices and printers. Increasingly, high capacity memory devices are being connected to the system through what might be described as general-purpose input/output adapters, such as USB or FireWire adapters. Finally, the system includes one or more network adapters 142 that are used to connect the system to other computer systems through intervening computer networks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for enhancing collaboration opportunities for a reply to an electronic message previously sent to two or more messaging clients, said method comprising:
receiving a first notice from a first messaging client to which said message was previously sent that a first user has initiated preparation of a reply to said message;
receiving a second notice from a second messaging client to which said message was previously sent that a second user has initiated preparation of a reply to said message;
sending a third notice to at least one of the first and second users that another user has initiated preparation of a reply to said message.

2. A method according to claim 1 wherein sending a third notice to at least one of the first and second users further comprises sending the third notice to both of said first and second users.

3. A method according to claim 2 wherein sending a third notice to at least one of the first and second users that another user has initiated preparation of a reply to said message further comprises including at least one timestamp in said notice indicating the time at which said first user initiated preparation of a reply to said message.

4. A method according to claim 3 wherein sending a third notice to at least one of the first and second users that another user has initiated preparation of a reply to said message further comprises sending the third notice in the form of an instant message.

5. A method according to claim 4 further comprising:
receiving a collaboration request from one of the first and second users to whom a third notice was sent; and
opening an instant messaging session between the first and second users.

6. A computer program product for enhancing collaboration opportunities for a reply to an electronic message previously sent to two or more messaging clients, said computer program product comprising a computer usable medium having computer usable program code embodied therewith, said computer usable program code comprising:
computer usable program code configured to receive a first notice from a first messaging client to which said message was previously sent that a first user has initiated preparation of a reply to said message;
computer usable program code configured to receive a second notice from a second messaging client to which said message was previously sent that a second user has initiated preparation of a reply to said message;
computer usable program code configured to send a third notice to at least one of the first and second users that another user has initiated preparation of a reply to said message.

7. A computer program product according to claim 6 wherein said computer usable program code configured to send a third notice to at least one of the first and second users that another user has initiated preparation of a reply to said message further comprises computer usable program code configured to send the third notice to both of said first and second users.

8. A computer program product according to claim 7 wherein said computer usable program code configured to send sending a third notice to at least one of the first and second users that another user has initiated preparation of a reply to said message further comprises computer usable program code configured to include at least one timestamp in said third notice indicating the time at which said another user initiated preparation of a reply to said message.

9. A computer program product according to claim 8 wherein said computer usable program code configured to send a third notice to at least one of the first and second users that another user has initiated preparation of a reply to said message further comprises computer usable program code configured to send the third notice in the form of an instant message.

10. A computer program product according to claim 9 further comprising:
computer usable program code configured to receive a collaboration request from one of the first and second users to whom a third notice was sent; and
computer usable program code configured to open an instant messaging session between the first and second users.

11. A messaging server for enhancing collaboration opportunities for a reply to an electronic message previously sent to two or more messaging clients, said messaging server comprising:
a receiver component for receiving notices from two or more messaging clients that users of said clients have initiated preparation of a reply to said previously sent message; and
a notification component for sending a notice to a least one of said messaging client that a user of another messaging client has initiated preparation of a reply to said previously sent message.

12. A messaging server according to claim 11 wherein said notification component sends the notice to both of the said first and second users.

13. A messaging server according to claim 12 wherein the notice sent by said notification component further includes a timestamp indicating the time at which said another user initiated preparation of a reply to said previously sent message.

14. A messaging server according to claim 13 wherein said notification component further comprises an instant messaging system.

15. A messaging server according to claim 14 further comprising:
an instant messaging receiving component for receiving a collaboration request from a user to which a notice has been sent; and
an instant messaging session control component for opening an instant messaging session between at least two users to whom notices had been sent.
